(19) United States
(12) Patent Application Publication
(10) Pub. No.: US 2009/0195482 A1
(43) Pub. Date: Aug. 6, 2009

(54) PDP DRIVER AND SEMICONDUCTOR INTEGRATED CIRCUIT FOR DRIVING PDP

(76) Inventors: Eisaku MAEDA, Osaka (JP); Hiroshi ANDO, Osaka (JP); Naoki HISHIKAWA, Osaka (JP); Jinsaku KANEDA, Osaka (JP); Hiroki MATSUNAGA, Osaka (JP)

Correspondence Address: MCDERMOTT WILL & EMERY LLP, 600 13TH STREET, NW, WASHINGTON, DC, 20005-3096, US

(21) Appl. No.: 12/240,296

(22) Filed: Sep. 29, 2008

(30) Foreign Application Priority Data
Feb. 4, 2008 (JP) 2008-024219

(51) Int. Cl. G09G 3/28

(52) U.S. Cl. 345/60

(57) ABSTRACT

A PDP-driving semiconductor integrated circuit includes a plurality of PDP drivers each for converting an input signal into a high-voltage pulse having an amplitude greater than that of the input signal and outputting the high-voltage pulse. The PDP-driving semiconductor integrated circuit has a function of performing sequential operation in which the PDP drivers operate at different timings and sequentially output the high-voltage pulses and a function of performing simultaneous operation in which the PDP drivers operate at the same timing and output the high-voltage pulses at a time. In each of the sequential operation and the simultaneous operation, at least one of the speed of change in voltage level of the high-voltage pulse from a low level to a high level and the speed of change in voltage level of the high-voltage pulse from the high level to the low level is controlled.

### BACKGROUND OF THE INVENTION

The present invention relates to plasma display panel (PDP) drivers and semiconductor integrated circuits for driving PDPs in plasma display apparatus.

Now, a circuit configuration of a conventional PDP driver will be described.

FIG. 11 illustrates a circuit configuration of a conventional PDP driver.

As illustrated in FIG. 11, the conventional PDP driver 13 includes: a level shift circuit 2; an output circuit 3; and a low-voltage control circuit 7 connected to a low-voltage power supply terminal VDD. An output load CL is a plasma display panel.

Specifically, the level shift circuit 2 includes: PMOS transistors P1 and P2 whose sources are both connected to a high-voltage power supply terminal VDDH and drains are connected to respective nodes IN5 and IN4 and which are connected to each other with their gates crossed; and NMOS transistors N1 and N2 whose gates are connected to respective nodes IN1 and IN2 of the low-voltage control circuit 7, drains are connected to the respective nodes IN5 and IN4, and sources are both grounded. The output circuit 3 includes: an NMOS transistor N3 (low-side transistor) whose gate is connected to a node IN3 of the low-voltage control circuit 7, drain is connected to an output terminal OUT, and source is grounded; and a PMOS transistor P3 (high-side transistor) whose source is connected to the high-voltage power supply terminal VDDH, gate is connected to the node IN5, and drain is connected to the output terminal OUT.

Now, it will be described how the conventional PDP driver operates.

FIG. 12 shows voltage waveforms of input/output signals of the low-voltage control circuit 7, the nodes IN1 through IN5, and the output terminal OUT.

As shown in FIG. 12, when the voltage level at the node IN is switched from a low level (which is the GND level in this case) to a high level (which is the VDD level in this case), a signal at the node IN1 output from the low-voltage control circuit 7 causes the NMOS transistor N1 to turn ON so that the voltage level at the node IN4 drops to the ground potential (GND) to cause the PMOS transistor P2 to turn ON. Then, the voltage level at the node IN5 increases to the level of the high-voltage power supply (VDDH) so that the PMOS transistor P3 turns ON. At the same time, a signal at the node IN2 output from the low-voltage control circuit 7 causes the NMOS transistor N2 to turn OFF and a signal at the node IN3 output from the low-voltage control circuit 7 causes the NMOS transistor N3 to turn ON. In this manner, the output voltage waveform VOUT at the output terminal OUT drops to the ground potential (GND).

On the other hand, when the voltage level at the node IN is switched from the high level to the low level, a signal at the node IN2 output from the low-voltage control circuit 7 causes the NMOS transistor N2 to turn ON so that the voltage level at the node IN5 drops to the ground potential (GND) to cause the PMOS transistor P3 to turn ON. At the same time, a signal at the node IN1 output from the low-voltage control circuit 7 causes the NMOS transistor N1 to turn OFF and a signal at the node IN3 output from the low-voltage control circuit 7 causes the NMOS transistor N3 to turn OFF, thereby transmitting a signal at the node IN. In this manner, the output voltage waveform VOUT at the output terminal OUT increases to the level of the high-voltage power supply (VDDH). In FIG. 12, IOUT indicates output-terminal current caused by a change in VOUT waveform.

As described above, through the foregoing operation, the conventional PDP driver 13 converts a signal input to the low-voltage control circuit 7 into a given high-voltage pulse with an amplitude greater than that of the input signal.

FIG. 13 illustrates a configuration of a conventional PDP-driving semiconductor integrated circuit 200 including a plurality of PDP drivers 13 described above.

As illustrated in FIG. 13, the conventional PDP-driving semiconductor integrated circuit 200 includes a plurality of PDP drivers 13 shown in FIG. 11 as unit driver circuits and also includes a logic circuit 5 for controlling the PDP drivers 13. Each of the PDP drivers 13 includes the level shift circuit 2, the output circuit 3, and the low-voltage control circuit 7, as described above.

The logic circuit 5 has functions such as the function of performing sequential operation in which the PDP drivers 13 sequentially output signals and the function of performing simultaneous operation in which the PDP drivers 13 output signals at a time. These functions are necessary for driving electrodes of plasma display apparatus. To perform operation such as sequential operation and simultaneous operation, the logic circuit 5 sends control signals to the low-voltage control circuits 7 of the PDP drivers 13 through control lines L.

In performing the simultaneous operation in the foregoing PDP-driving semiconductor integrated circuit 200 illustrated in FIG. 13, when the capacitive load CL is connected to outputs OUT1 through OUTn of the PDP drivers 13, output-terminal current IOUT shown in FIG. 12 flows so that collective power-supply current IVDDH in an amount corresponding to the output current×the number of PDP drivers flows. As a result, this collective power-supply current might cause an increase of power consumption of the PDP-driving semiconductor integrated circuit or degrade the reliability thereof. In addition, it is known that the flow of noise current maximized at a point in a power supply or a referential potential affects a power-supply load, the power supply, or wiring of the reference potential and causes unnecessary noise and radiation interference associated with high-speed operation.

To prevent the increase in power consumption and the radiation interference mentioned above, proposed is a method for adjusting the speed at which the waveform of an output voltage from each of the PDP drivers 13 changes from the high level to the low level or from the low level to the high level, by changing the ON resistance of transistors in a prebuffer. For the foregoing description, see Japanese Examined Patent Publication No. 6-91442 (FIG. 1) and Japanese Laid-Open Patent Publication No. 2006-78935 (FIG. 7), for example.

However, to output a control signal for controlling the speed of change in output voltage waveform from the logic circuit 5 to the low-voltage control circuit 7 in the conventional PDP-driving semiconductor integrated circuit 200, four control lines L, which is the sum of two control signal lines for controlling the high-side transistor in the output circuits 3 and two control signal lines for controlling the low-side transistor in the output circuit 3, are necessary. Thus, increase in chip area associated with the control lines L is inevitable in the PDP-driving semiconductor integrated circuit 200 including the plural PDP drivers 13.

In addition, the method for controlling the speed of change in output voltage waveform is a method of detecting a change of output signals from adjacent PDP drivers 13 to make the transition time of the output voltage from each PDP driver constant according to the output signal. Accordingly, it is possible to control the speed of change in output voltage waveform in performing the sequential operation, whereas it is impossible to control the speed of change in output voltage waveform in performing the simultaneous operation.

### SUMMARY OF THE INVENTION

It is therefore an object of the present invention to avoid increases in circuit scale and number of control lines in order to reduce noise occurring in simultaneous operation of PDP drivers and the associated electromagnetic interference (hereinafter, referred to as EMI).

To achieve the object, a PDP-driving semiconductor integrated circuit according to an embodiment of the present invention includes a plurality of PDP drivers each for converting an input signal into a high-voltage pulse having an amplitude greater than that of the input signal and outputting the high-voltage pulse. The PDP-driving semiconductor integrated circuit has a function of performing sequential operation in which the PDP drivers operate at different timings and sequentially output the high-voltage pulses and a function of performing simultaneous operation in which all the PDP drivers operate at the same timing and output the high-voltage pulses at a time. In each of the sequential operation and the simultaneous operation, at least one of the speed of change in voltage level of the high-voltage pulse from a low level to a high level and the speed of change in voltage level of the high-voltage pulse from the high level to the low level is controlled.

In the PDP-driving semiconductor integrated circuit, the speed of change in voltage level of the high-voltage pulse from the low level to the high level controlled in the simultaneous operation is lower than the speed of change in voltage level of the high-voltage pulse from the low level to the high level controlled in the sequential operation, and the speed of change in voltage level of the high-voltage pulse from the high level to the low level controlled in the simultaneous operation is lower than the speed of change in voltage level of the high-voltage pulse from the high level to the low level controlled in the sequential operation

A PDP driver according to an embodiment of the present invention includes: a low-voltage control circuit connected to a low-voltage power supply and outputting a low-voltage signal and a signal in opposite phase to the low-voltage signal based on an input signal; a level shift circuit including a first PMOS transistor whose source is connected to a high-voltage power supply, drain is connected to a first node, and gate is connected to a second node, a second PMOS transistor whose source is connected to the high-voltage power supply, drain is connected to the second node, and gate is connected to the first node, a first NMOS transistor whose gate receives the low-voltage signal, drain is connected to the first node, and source is connected to a ground potential, and a second NMOS transistor whose gate receives the signal in opposite phase to the low-voltage signal, drain is connected to the second node, and source is connected to the ground potential; and an output circuit including a high-side transistor whose source is connected to the high-voltage power supply and gate is connected to the second node and a low-side transistor whose source is connected to the ground potential and gate receives the low-voltage signal. The output circuit has an output node to which the high-side transistor and a drain of the low-side transistor are commonly connected. The PDP driver converts the input signal into a high-voltage pulse having an amplitude greater than that of the input signal and outputs the high-voltage pulse. The low-voltage control circuit is configured to control at least one of the speed of change in voltage level of the high-voltage pulse from a low level to a high level and the speed of change in voltage level of the high-voltage pulse from the high level to the low level.

In the PDP driver, the low-voltage control circuit includes a slew-rate control circuit. Each of the speed of change in voltage level of the high-voltage pulse from the low level to the high level and the speed of change in voltage level of the high-voltage pulse from the high level to the low level is controlled based on a control signal input from outside the slew-rate control circuit.

In the PDP driver, the slew-rate control circuit includes at least one of a first prebuffer for controlling the gate of the second NMOS transistor and a second prebuffer for controlling the gate of the low-side transistor. The speed of change in voltage level of the high-voltage pulse from the low level to the high level is controlled by changing an ON resistance of a load transistor out of transistors forming the first prebuffer based on the control signal. The speed of change in voltage level of the high-voltage pulse from the high level to the low level is controlled by changing an ON resistance of a load transistor out of transistors forming the second prebuffer based on the control signal.

In the PDP driver, the load transistor of the first prebuffer is formed by two first load transistors connected in parallel with each other and the load transistor of the second prebuffer is formed by two second load transistors connected in parallel with each other. The speed of change in voltage level of the high-voltage pulse from the low level to the high level is controlled by controlling the number of transistors in ON states out of the two first load transistors based on the control signal. The speed of change in voltage level of the high-voltage pulse from the high level to the low level is controlled by controlling the number of transistors in ON states out of the two second load transistors based on the control signal.

In the PDP driver, each of the first load transistors and the second load transistors is controlled according to a signal obtained by performing AND operation on the input signal and the control signal, in controlling an associated one of the speeds.

In the PDP driver, the first load transistors and the second load transistors have different transistor sizes.

In the inventive PDP-driving semiconductor integrated circuit, simultaneous operation and sequential operation are detected and the output waveform in the simultaneous operation changes more slowly than that in the sequential operation. Thus, the reliability is enhanced with an increase in power consumption in the simultaneous operation suppressed as well as noise and EMI are reduced. The inventive PDP drivers needs only one control signal for controlling the speed of change in output waveform, thus preventing an increase in circuit scale of a PDP-driving semiconductor integrated circuit including a plurality of PDP drivers.

### BRIEF DESCRIPTION OF THE DRAWINGS

FIG. 1 is a view schematically illustrating a configuration of a PDP-driving semiconductor integrated circuit according to a first embodiment of the present invention.

FIG. 2 is a circuit diagram illustrating a configuration of a PDP driver according to the first embodiment.

FIG. 3 is table showing changes of an input signal and a control signal, ON/OFF states of PMOS transistors, and the speed of change of a signal output from an output terminal according to the first embodiment.

FIG. 4 is a timing chart showing operation of the PDP driver of the first embodiment.

FIG. 5 is a circuit diagram illustrating a configuration of a PDP driver according to a second embodiment of the present invention.

FIG. 6 is a circuit diagram illustrating a configuration of a PDP driver according to a third embodiment of the present invention.

FIG. 7 is a circuit diagram illustrating a configuration of a PDP driver according to a fourth embodiment of the present invention.

FIG. 8 is a circuit diagram illustrating a configuration of a PDP driver according to a fifth embodiment of the present invention.

FIG. 9 is a circuit diagram illustrating a configuration of a PDP driver according to a sixth embodiment of the present invention.

FIG. 10 is a plan view illustrating a layout of a PDP-driving semiconductor integrated circuit according to a seventh embodiment of the present invention.

FIG. 11 is a circuit diagram illustrating a configuration of a conventional PDP driver.

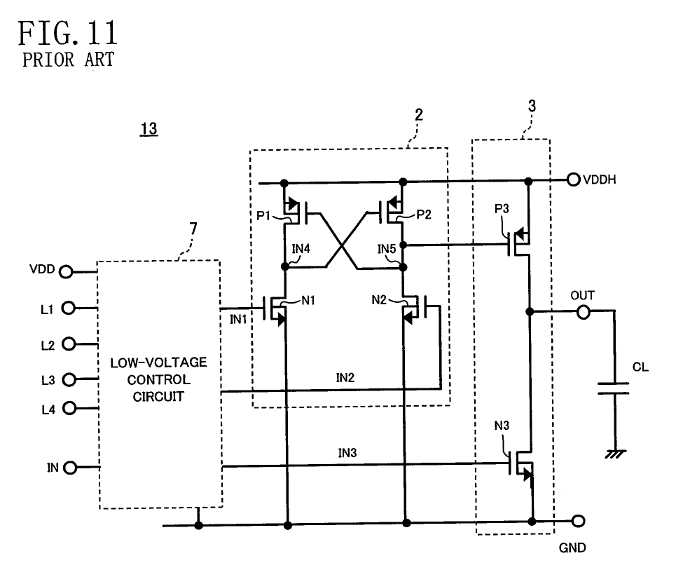

FIG. 12 is a timing chart showing operation of the conventional PDP driver.

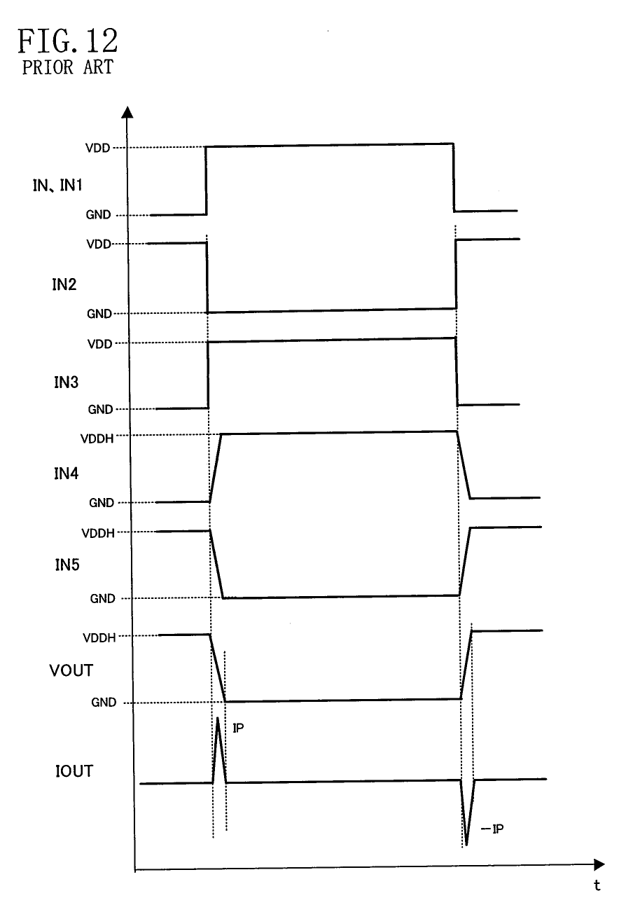

FIG. 13 is a circuit diagram schematically illustrating a configuration of a conventional PDP-driving semiconductor integrated circuit.

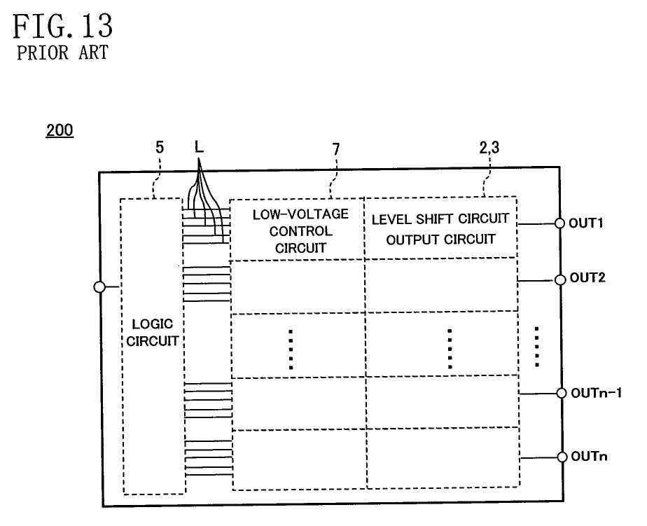

### DETAILED DESCRIPTION OF THE INVENTION

Hereinafter, embodiments of the present invention will be described with reference to the drawings.

### Embodiment 1

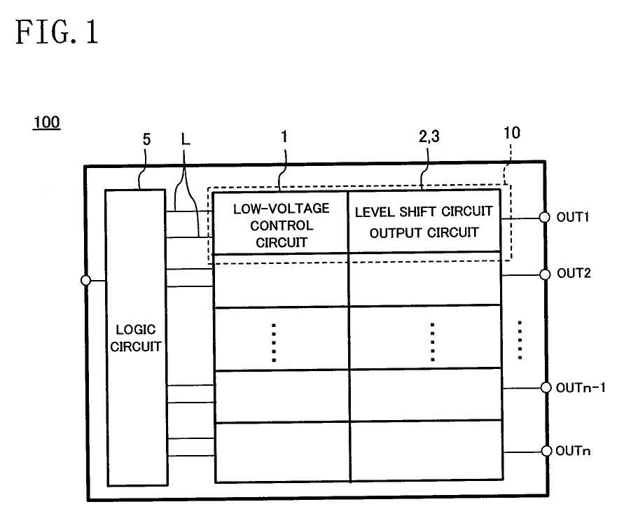

FIG. 1 illustrates a configuration of a PDP-driving semiconductor integrated circuit 100 according to a first embodiment of the present invention.

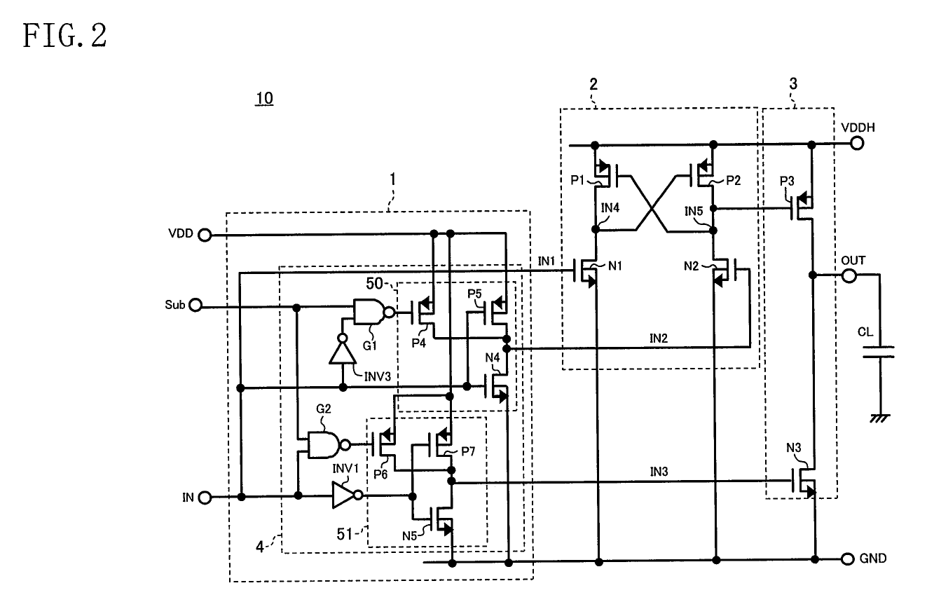

As illustrated in FIG. 1, the PDP-driving semiconductor integrated circuit 100 of the first embodiment includes a plurality of PDP drivers 10, which will be specifically described with reference to FIG. 2, and a logic circuit 5. Each of the PDP drivers 10 is a unit driver circuit and includes: a low-voltage control circuit 1; a level shift circuit 2; and an output circuit 3. The logic circuit 5 has functions such as the function of performing sequential operation in which the PDP drivers 10 sequentially output signals and the function of performing simultaneous operation in which the PDP drivers 10 output signals at a time. These functions are necessary for driving electrodes of plasma display apparatus. To perform operation such as sequential operation and simultaneous operation, the logic circuit 5 sends control signals to the low-voltage control circuits 1 of the PDP drivers 10 through control lines L.

FIG. 2 specifically illustrates a circuit configuration of one of the PDP drivers 10 illustrated in FIG. 1.

As illustrated in FIG. 2, each of the PDP drivers 10 of the first embodiment includes: the low-voltage control circuit 1 having a slew-rate control circuit 4; the level shift circuit 2; and the output circuit 3. The low-voltage control circuit 1 includes: PMOS transistors P4 through P7; NMOS transistors N4 and N5; NAND gates G1 and G2; and inverters INV1 and INV3. The circuit configurations of the level shift circuit 2 and the output circuit 3, a high-voltage power supply terminal VDDH, a low-voltage power supply terminal VDD, a ground potential terminal GND, an output terminal OUT, and an output load CL are the same as described in BACKGROUND OF THE INVENTION and, therefore, descriptions thereof are herein omitted.

Specifically, the slew-rate control circuit 4 of the low-voltage control circuit 1 receives an input signal IN for controlling the level shift circuit 2 and the output circuit 3 and a control signal Sub for selecting one of the sequential operation and the simultaneous operation through the control line L (see FIG. 1). A prebuffer 50 formed by the PMOS transistors P4 and P5 and the NMOS transistor N4 in the slew-rate control circuit 4 drives the gate of an NMOS transistor N2 in the level shift circuit 2. A prebuffer 51 formed by the PMOS transistors P6 and P7 and the NMOS transistor N5 drives the gate of an NMOS transistor N3 in the output circuit 3. In the prebuffer 50, the gate of the PMOS transistor P4 is connected to the NAND gate G1 to which the input signal IN through the inverter INV3 and the control signal Sub are input and the gate of the PMOS transistor P5 and the gate of the NMOS transistor N4 receive the input signal IN. On the other hand, in the prebuffer 51, the gate of the PMOS transistor P6 is connected to the NAND gate G2 to which the control signal Sub and the input signal IN are input and the gate of the PMOS transistor P7 and the gate of the NMOS transistor N5 receive the input signal IN through the inverter INV1.

Now, it will be described how the speeds of changes of output signals in the sequential operation and the simultaneous operation of the PDP driver 10 of this embodiment are controlled.

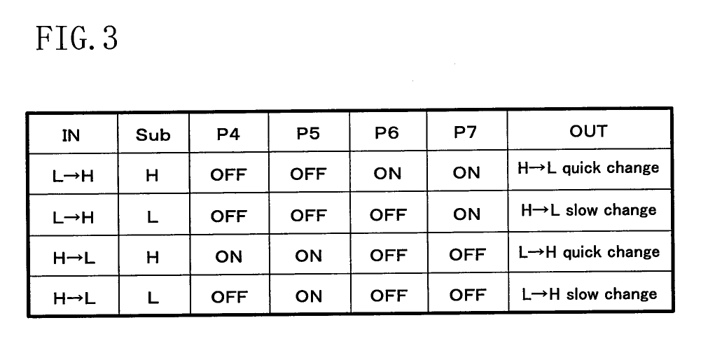

FIG. 3 shows changes of the input signal IN, the control signal Sub, ON/OFF states of the PMOS transistors P4 through P7, and the speed of change of a signal output from the output terminal OUT. In FIG. 3, “H” denotes a high level of the signal voltage level, “L” denotes a low level of the signal voltage level, “L→H” denotes a change of the signal voltage level from the low level to the high level, and “H→L” denotes a change of the signal voltage level from the high level to the low level.

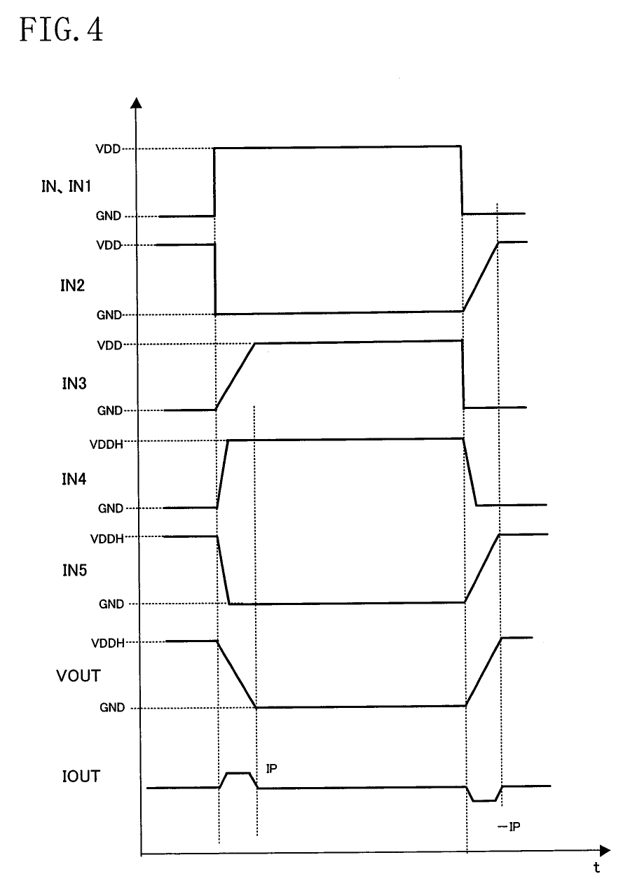

FIG. 4 shows changes of the input and output of the PDP driver 10 illustrated in FIG. 1 and signals at the respective nodes.

As shown in FIG. 4, in this embodiment, the control signal Sub at the “H” level is input to the PDP-driving semiconductor integrated circuit 100 in the sequential operation, whereas the control signal Sub at the “L” level is input in the simultaneous operation.

In the sequential operation in which the control signal Sub at the “H” level is input, when the input signal IN changes from “L” to “H”, the NAND gates G1 and G2 for controlling the prebuffers 50 and 51 turn the PMOS transistors P4 and P5 serving as loads of the prebuffer 50 OFF and the PMOS transistors P6 and P7 serving as loads of the prebuffer 51 ON, thereby quickly changing the output signal from “H” to “L”.

In contrast, when the input signal IN changes from “H” to “L”, the NAND gates G1 and G2 for controlling the prebuffers 50 and 51 turn the PMOS transistors P4 and P5 serving as loads of the prebuffer 50 ON and the PMOS transistors P6 and P7 serving as loads of the prebuffer 51 OFF, thereby quickly changing the output signal from “L” to On the other hand, in the simultaneous operation in which the control signal Sub at the “L” level is input, when the input signal IN changes from “L” to “H”, the NAND gates G1 and G2 for controlling the prebuffers 50 and 51 turn the PMOS transistors P4 and P5 serving as loads of the prebuffer 50 OFF, while turning the PMOS transistor P6 serving as a load of the prebuffer 51 OFF and the PMOS transistor P7 serving as a load of the prebuffer 51 ON. Accordingly, the ON resistance of the load transistors of the prebuffer 51 is higher than that in the sequential operation described above so that the output signal slowly changes from “H” to “L”.

In the same manner, when the input signal IN changes from “H” to “L”, the NAND gates G1 and G2 for controlling the prebuffers 50 and 51 turn the PMOS transistor P4 serving as a load of the prebuffer 50 OFF, the PMOS transistor P5 serving as a load of the prebuffer 50 ON, and the PMOS transistors P6 and P7 serving as loads of the prebuffer 51 OFF. Accordingly, the ON resistance of the load transistors of the prebuffer 50 is higher than that in the sequential operation described above so that the output signal slowly changes from “L” to “H”.

As described above, the PDP drivers of this embodiment are configured in such a manner that the output signal in the simultaneous operation changes more slowly than in the sequential operation. Accordingly, the output current IOUT from the output terminal shows a gentle current waveform having no peaks as shown in FIG. 4, thus enhancing the reliability with an increase in power consumption in the simultaneous operation suppressed and reducing noise and EMI. To obtain more advantages, the transistor sizes of the PMOS transistors P5 and P7 in the prebuffers 50 and 51 are preferably smaller than those of the PMOS transistors P4 and P6.

### Embodiment 2

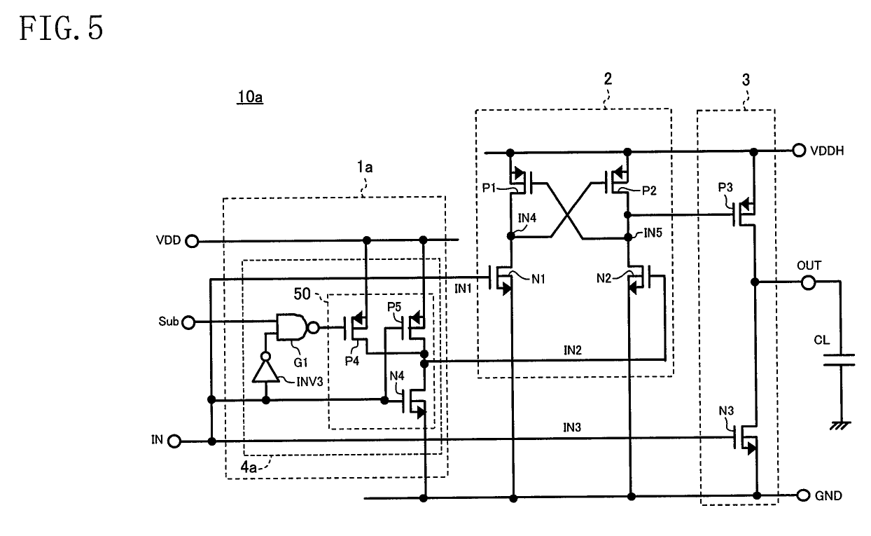

FIG. 5 specifically illustrates a circuit configuration of a PDP driver 10a according to a second embodiment of the present invention. The PDP driver 10a illustrated in FIG. 5 is mounted on the PDP-driving semiconductor integrated circuit 100 shown in FIG. 1, as in the first embodiment.

The PDP driver 10a of this embodiment illustrated in FIG. 5 is different from the PDP driver 10 of the first embodiment illustrated in FIG. 2 in the configuration of a slew-rate control circuit 4a in a low-voltage control circuit la, which corresponds to the slew-rate control circuit 4 in the low-voltage control circuit 1 of the PDP driver 10 of the first embodiment. In the other aspects, the PDP driver 10a is the same as the PDP driver 10.

Specifically, the slew-rate control circuit 4a in the low-voltage control circuit 1a of this embodiment includes a prebuffer 50 but not includes a prebuffer 51, and thus is different from the slew-rate control circuit 4 of the first embodiment including both the prebuffers 50 and 51.

More specifically, the slew-rate control circuit 4a receives an input signal IN for controlling a level shift circuit 2 and an output circuit 3 and a control signal Sub for selecting one of sequential operation and simultaneous operation through a control line L (see FIG. 1). The prebuffer 50 formed by PMOS transistors P4 and P5 and an NMOS transistor N4 in the slew-rate control circuit 4a drives the gate of an NMOS transistor N2 in the level shift circuit 2. The gate of the PMOS transistor P4 in the prebuffer 50 is connected to a NAND gate G1 to which the input signal IN through an inverter INV3 and the control signal Sub are input. The gate of the PMOS transistor P5 and the gate of the NMOS transistor N4 receive the input signal IN.

With the foregoing configuration, internal operation of the PDP driver 10a of this embodiment in sequential operation and simultaneous operation is the same as the above-described operation of the PDP driver 10 of the first embodiment but, since the slew-rate control circuit 4a includes the prebuffer 50 and no prebuffer 51, the control of the speed of change of an output signal is applied only to a rise from the low level to the high level. Thus, in the case where noise and EMI are due to different causes which have been found to be an abrupt change at the rising of an output signal from the PDP driver in plasma display apparatus using the PDP-driving semiconductor integrated circuit 100, even the PDP driver 10a of this embodiment having a smaller number of components enhances the reliability with an increase in power consumption in simultaneous operation suppressed and reduces noise and EMI.

### Embodiment 3

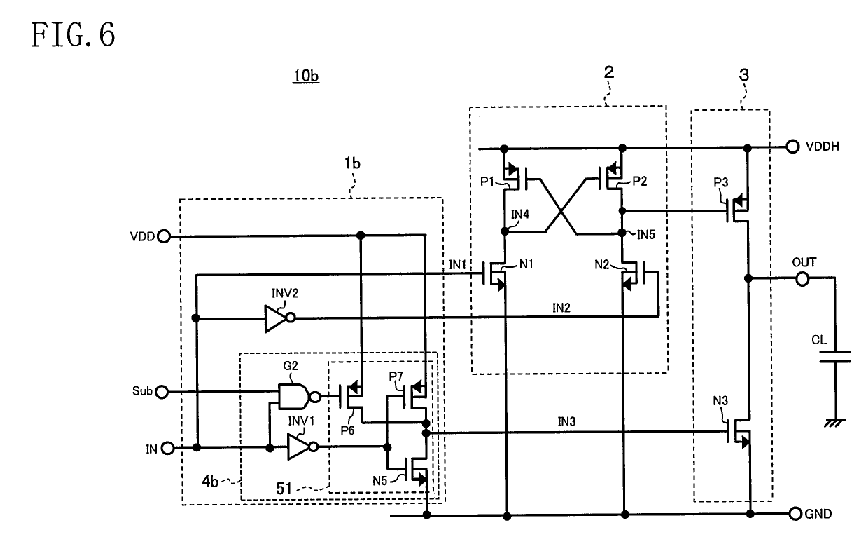

FIG. 6 specifically illustrates a circuit configuration of a PDP driver 10b according to a third embodiment of the present invention. The PDP driver 10b illustrated in FIG. 6 is mounted on the PDP-driving semiconductor integrated circuit 100 shown in FIG. 1, as in the first embodiment.

The PDP driver 10b of this embodiment illustrated in FIG. 6 is different from the PDP driver 10 of the first embodiment illustrated in FIG. 2 in the configuration of a slew-rate control circuit 4b in a low-voltage control circuit 1b of the PDP driver 10b, which corresponds to the slew-rate control circuit 4 in the low-voltage control circuit 1 of the PDP driver 10 of the first embodiment. In the other aspects, the PDP driver 10b is the same as the PDP driver 10.

Specifically, the slew-rate control circuit 4b in the low-voltage control circuit 1b of this embodiment includes a prebuffer 51 but not includes a prebuffer 50, and thus is different from the slew-rate control circuit 4 of the first embodiment including both the prebuffers 50 and 51.

More specifically, the slew-rate control circuit 4b receives an input signal IN for controlling a level shift circuit 2 and an output circuit 3 and a control signal Sub for selecting one of sequential operation and simultaneous operation through a control line L (see FIG. 1). The prebuffer 51 formed by PMOS transistors P6 and P7 and an NMOS transistor N5 in the slew-rate control circuit 4b drives the gate of an NMOS transistor N3 in the output circuit 3. The gate of the PMOS transistor P6 in the prebuffer 51 is connected to a NAND gate G2 to which the control signal Sub and the input signal IN are input. The gate of the PMOS transistor P7 and the gate of the NMOS transistor N5 receive the input signal IN through an inverter INV1. The input signal IN is input to an NMOS transistor N2 in the level shift circuit 2 through an inverter INV2.

With the foregoing configuration, internal operation of the PDP driver 10b of this embodiment in sequential operation and simultaneous operation is the same as the above-described operation of the PDP driver 10 of the first embodiment but, since the slew-rate control circuit 4b includes the prebuffer 51 and no prebuffer 50, the control of the speed of change of an output signal is applied only to a drop from the high level to the low level. Thus, in the case where noise and EMI are due to different causes which have been found to be an abrupt change at the falling of an output signal from the PDP driver in plasma display apparatus using the PDP-driving semiconductor integrated circuit 100, even the PDP driver 10b of this embodiment having a smaller number of components enhances the reliability with an increase in power consumption in simultaneous operation suppressed and reduces noise and EMI.

### Embodiment 4

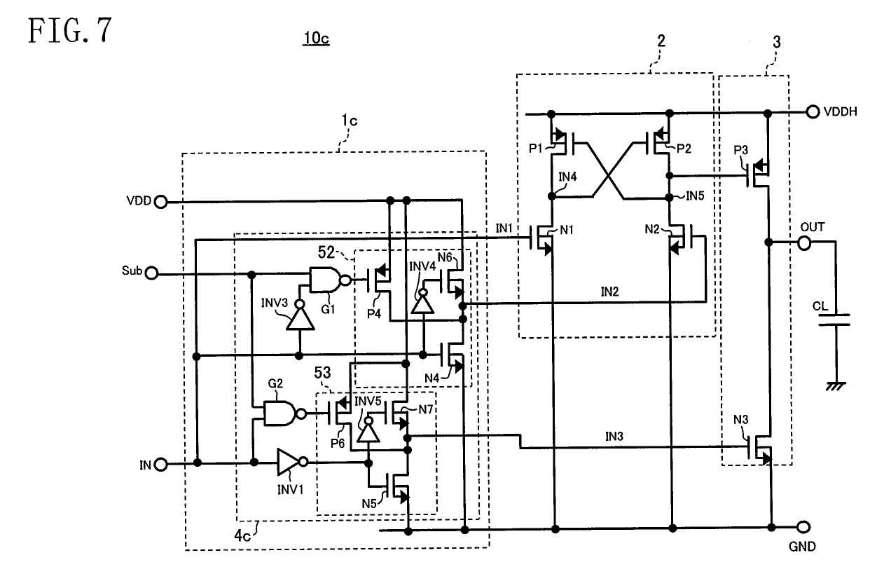

FIG. 7 specifically illustrates a circuit configuration of a PDP driver 10c according to a fourth embodiment of the present invention. The PDP driver 10c illustrated in FIG. 7 is mounted on the PDP-driving semiconductor integrated circuit 100 shown in FIG. 1, as in the first embodiment.

The PDP driver 10c of this embodiment illustrated in FIG. 7 is different from the PDP driver 10 of the first embodiment illustrated in FIG. 2 in the configuration of a slew-rate control circuit 4c in a low-voltage control circuit 1c of the PDP driver 10c, which corresponds to the slew-rate control circuit 4 in the low-voltage control circuit 1 of the PDP driver 10 of the first embodiment. In the other aspects, the PDP driver 10c is the same as the PDP driver 10.

Specifically, the slew-rate control circuit 4c in the low-voltage control circuit 1c of this embodiment includes prebuffers 52 and 53, and thus is different from the slew-rate control circuit 4 of the first embodiment including the prebuffers 50 and 51. More specifically, the prebuffers 52 and 53 are different from the prebuffers 50 and 51 in that load transistors of the prebuffer 52 are a PMOS transistor P4, an NMOS transistor N6, and an inverter INV4 and that load transistors of the prebuffer 53 are a PMOS transistor P6, an NMOS transistor N7 and an inverter INV5.

The method for controlling the speeds of changes in output voltage waveform in sequential operation and simultaneous operation is the same as in the PDP driver 10 of the first embodiment and, thus, description thereof is herein omitted.

In the PDP driver 10c of this embodiment with the foregoing configuration, a voltage of 5V is generally applied to a low-voltage power supply terminal VDD. As described above, in simultaneous operation in which the control signal Sub at the “L” level is input, when only the NMOS transistor N6 or N7 turns ON, the voltages at nodes IN2 and IN3 applied to NMOS transistors N2 and N3 do not increase to the VDD potential (which is generally 5V) because of the presence of the threshold voltage Vt of the NMOS transistor N6 or N7, but increase to approximately 4.3V. Accordingly, the NMOS transistors N2 and N3 have driving abilities lower than those in the case where 5V is applied to their gates, thus reducing the speed of change in output voltage waveform.

As described above, the PDP drive 10c of this embodiment are configured in such a manner that the output signal waveform in the simultaneous operation changes more slowly than in the sequential operation. Accordingly, as in the case shown FIG. 4, the output current IOUT from the output terminal shows a gentle waveform having no peaks, thus enhancing the reliability with an increase in power consumption in the simultaneous operation suppressed and reducing noise and EMI. To obtain more advantages, the transistor sizes of the PMOS transistors P6 and P7 serving as loads in the prebuffers 52 and 53 are preferably smaller than those of the PMOS transistors P4 and P6.

### Embodiment 5

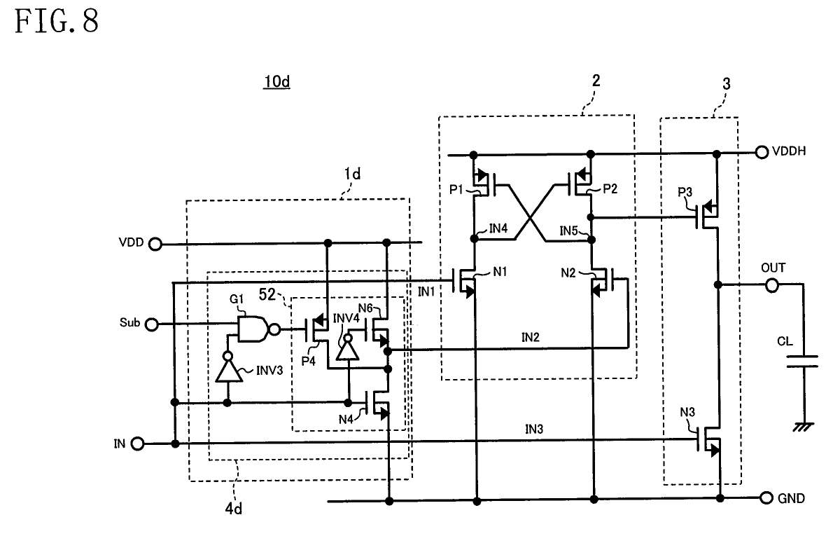

FIG. 8 specifically illustrates a circuit configuration of a PDP driver 10d according to a fifth embodiment of the present invention. The PDP driver 10d illustrated in FIG. 8 is mounted on the PDP-driving semiconductor integrated circuit 100 shown in FIG. 1, as in the first embodiment.

The PDP driver 10d of this embodiment illustrated in FIG. 8 is different from the PDP driver 10c of the fourth embodiment illustrated in FIG. 7 in the configuration of a slew-rate control circuit 4d in a low-voltage control circuit 1d of the PDP driver 10d, which corresponds to the slew-rate control circuit 4c in the low-voltage control circuit 1c of the PDP driver 10c of the fourth embodiment. In the other aspects, the PDP driver 10d is the same as the PDP driver 10c.

Specifically, the slew-rate control circuit 4d in the low-voltage control circuit 1d of this embodiment includes a prebuffer 52 but not includes a prebuffer 53, and thus is different from the slew-rate control circuit 4c of the fourth embodiment including the prebuffers 52 and 53.

More specifically, the slew-rate control circuit 4d receives an input signal IN for controlling a level shift circuit 2 and an output circuit 3 and a control signal Sub for selecting one of sequential operation and simultaneous operation through a control line L (see FIG. 1). The prebuffer 52 formed by a PMOS transistor P4 and NMOS transistors N4 and N6 in the slew-rate control circuit 4d drives the gate of an NMOS transistor N2 in the level shift circuit 2. The gate of the PMOS transistor P4 in the prebuffer 52 is connected to a NAND gate G1 to which the input signal IN through an inverter INV3 and the control signal Sub are input and the gate of the NMOS transistor N6 receives the input signal IN through an inverter INV4. The gate of the NMOS transistor N4 receives the input signal IN.

With the foregoing configuration, internal operation of the PDP driver 10d of this embodiment in sequential operation and simultaneous operation is the same as the above-described operation of the PDP driver 10c of the fourth embodiment but, since the slew-rate control circuit 4d includes the prebuffer 52 and no prebuffer 53, the control of the speed of change of an output signal is applied only to a rise from the low level to the high level. Thus, in the case where noise and EMI are due to different causes which have been found to be an abrupt change at the rising of an output signal from the PDP driver in plasma display apparatus using the PDP-driving semiconductor integrated circuit 100, even the PDP driver god of this embodiment having a smaller number of components enhances the reliability with an increase in power consumption in simultaneous operation suppressed and reduces noise and EMI.

### Embodiment 6

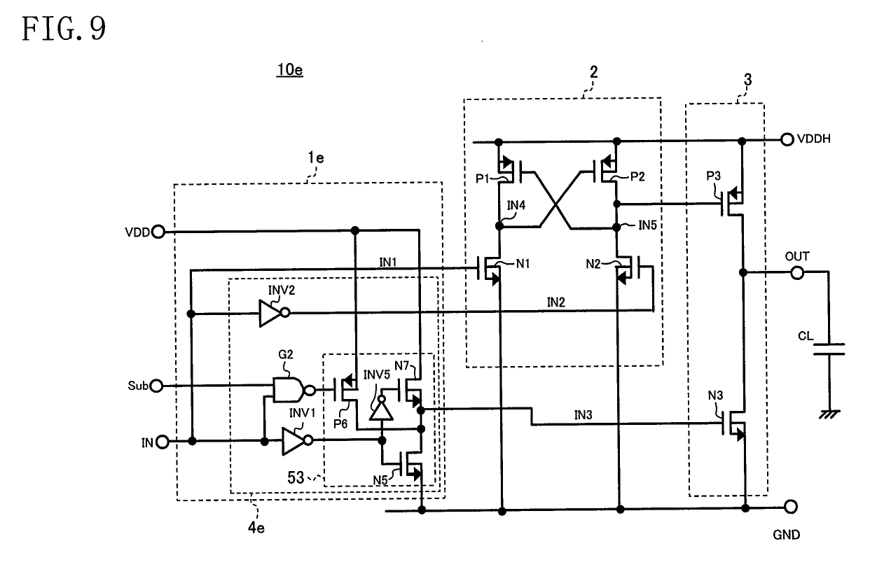

FIG. 9 specifically illustrates a circuit configuration of a PDP driver 10e according to a sixth embodiment of the present invention. The PDP driver 10e illustrated in FIG. 9 is mounted on the PDP-driving semiconductor integrated circuit 100 shown in FIG. 1, as in the first embodiment.

The PDP driver 10e of this embodiment illustrated in FIG. 9 is different from the PDP driver 10c of the fourth embodiment illustrated in FIG. 7 in the configuration of a slew-rate control circuit 4e in a low-voltage control circuit 1e of the PDP driver 10e, which corresponds to the slew-rate control circuit 4c in the low-voltage control circuit 1c of the PDP driver 10c of the fourth embodiment. In the other aspects, the PDP driver 10e is the same as the PDP driver 10c.

Specifically, the slew-rate control circuit 4e in the low-voltage control circuit le of this embodiment includes a prebuffer 53 but not includes a prebuffer 52, and thus is different from the slew-rate control circuit 4c of the fourth embodiment including the prebuffers 52 and 53.

More specifically, the slew-rate control circuit 4e receives an input signal IN for controlling a level shift circuit 2 and an output circuit 3 and a control signal Sub for selecting one of sequential operation and simultaneous operation through a control line L (see FIG. 1). The prebuffer 53 formed by a PMOS transistor P6 and NMOS transistors N5 and N7 in the slew-rate control circuit 4e drives the gate of an NMOS transistor N3 in the output circuit 3. The gate of the PMOS transistor P6 in the prebuffer 53 is connected to a NAND gate G2 to which the control signal Sub and the input signal IN are input. The gate of the NMOS transistor N7 receives the input signal IN through inverters INV1 and INV5. The gate of the NMOS transistor N5 receives the input signal IN. The input signal IN is input to an NMOS transistor N2 in the level shift circuit 2 through an inverter INV2.

With the foregoing configuration, internal operation of the PDP driver 10e of this embodiment in sequential operation and simultaneous operation is the same as the above-described operation of the PDP driver 10c of the fourth embodiment but, since the slew-rate control circuit 4e includes the prebuffer 53 and no prebuffer 52, the control of the speed of change of an output signal is applied only to a drop from the high level to the low level. Thus, in the case where noise and EMI are due to different causes which have been found to be an abrupt change at the falling of an output signal from the PDP driver in plasma display apparatus using the PDP-driving semiconductor integrated circuit 100, even the PDP driver 10e of this embodiment having a smaller number of components enhances the reliability with an increase in power consumption in simultaneous operation suppressed and reduces noise and EMI.

### Embodiment 7

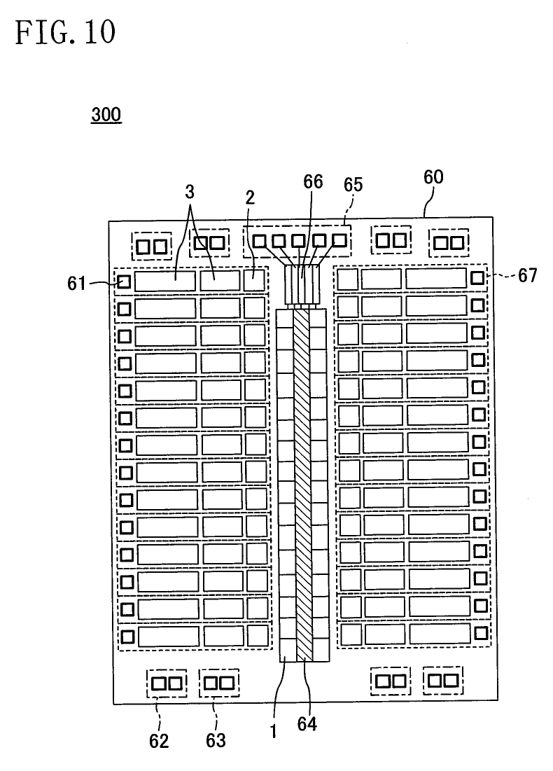

FIG. 10 is a plan view illustrating a configuration of a layout 300 of the PDP-driving semiconductor integrated circuit 100 shown in FIG. 1. This layout is applicable to the cases where the PDP drivers 10 and 10a through 10e of the first through sixth embodiments are mounted on the PDP-driving semiconductor integrated circuit 100.

As illustrated in FIG. 10, in the layout 300 of the PDP-driving semiconductor integrated circuit 100, low-voltage control circuits 1 are placed at the middle and level shift circuits 2, output circuits 3, and circuit cells 67 including pads 61 are opposed to each other with the low-voltage control circuits 1 sandwiched therebetween. Logic circuits 66 are placed at an end of the low-voltage control circuits 1. High-voltage power supply pads 62, reference voltage pads 63, and input control pads 65 are arranged in the rim of the PDP-driving semiconductor integrated circuit 100. A transmission region 64 for transmitting input signals IN and control signals Sub is placed on the low-voltage control circuits 1.

As described in the first through sixth embodiments, the PDP-driving semiconductor integrated circuit 100 of this embodiment needs one control signal line for controlling the speed of change in output waveform. Thus, in any of the cases of the PDP drivers 10 and 10a through 10e, the transmission region 64 for input signals IN and control signals Sub in the PDP-driving semiconductor integrated circuit 100 on which the PDP drivers are mounted is minimized.

In the foregoing first through seventh embodiments, description is given on the case where the low-side output transistor in the output circuit 3 is a MOS transistor. However, the present invention is also applicable to the case where the low-side output transistor is a transistor, such as an insulated gate bipolar transistor (IGBT) or a metal-oxide-semiconductor field-effect transistor (MOSFET), having an insulating gate.

The values such as the voltage values mentioned above are only examples, and the present invention is not limited to these values.

The present invention is useful for PDP drivers and PDP-driving semiconductor integrated circuits in plasma display apparatus.

What is claimed is:

1. A PDP-driving semiconductor integrated circuit, comprising a plurality of PDP drivers each for converting an input signal into a high-voltage pulse having an amplitude greater than that of the input signal and outputting the high-voltage pulse,
wherein the PDP-driving semiconductor integrated circuit has a function of performing sequential operation in which the PDP drivers operate at different timings and sequentially output the high-voltage pulses and a function of performing simultaneous operation in which all the PDP drivers operate at the same timing and output the high-voltage pulses at a time, and
in each of the sequential operation and the simultaneous operation, at least one of the speed of change in voltage level of the high-voltage pulse from a low level to a high level and the speed of change in voltage level of the high-voltage pulse from the high level to the low level is controlled.

2. The PDP-driving semiconductor integrated circuit of claim 1, wherein the speed of change in voltage level of the high-voltage pulse from the low level to the high level controlled in the simultaneous operation is lower than the speed of change in voltage level of the high-voltage pulse from the low level to the high level controlled in the sequential operation, and
the speed of change in voltage level of the high-voltage pulse from the high level to the low level controlled in the simultaneous operation is lower than the speed of change in voltage level of the high-voltage pulse from the high level to the low level controlled in the sequential operation

3. A PDP driver, comprising:
a low-voltage control circuit connected to a low-voltage power supply and outputting a low-voltage signal and a signal in opposite phase to the low-voltage signal based on an input signal;
a level shift circuit including a first PMOS transistor whose source is connected to a high-voltage power supply, drain is connected to a first node, and gate is connected to a second node, a second PMOS transistor whose source is connected to the high-voltage power supply, drain is connected to the second node, and gate is connected to the first node, a first NMOS transistor whose gate receives the low-voltage signal, drain is connected to the first node, and source is connected to a ground potential, and a second NMOS transistor whose gate receives the signal in opposite phase to the low-voltage signal, drain is connected to the second node, and source is connected to the ground potential; and
an output circuit including a high-side transistor whose source is connected to the high-voltage power supply and gate is connected to the second node and a low-side transistor whose source is connected to the ground potential and gate receives the low-voltage signal, the output circuit having an output node to which the high-side transistor and a drain of the low-side transistor are commonly connected,
wherein the PDP driver converts the input signal into a high-voltage pulse having an amplitude greater than that of the input signal and outputs the high-voltage pulse, and
the low-voltage control circuit is configured to control at least one of the speed of change in voltage level of the high-voltage pulse from a low level to a high level and the speed of change in voltage level of the high-voltage pulse from the high level to the low level.

4. The PDP driver of claim 3, wherein the low-voltage control circuit includes a slew-rate control circuit, and
each of the speed of change in voltage level of the high-voltage pulse from the low level to the high level and the speed of change in voltage level of the high-voltage pulse from the high level to the low level is controlled based on a control signal input from outside the slew-rate control circuit.

5. The PDP driver of claim 4, wherein the slew-rate control circuit includes at least one of a first prebuffer for controlling the gate of the second NMOS transistor and a second prebuffer for controlling the gate of the low-side transistor,
the speed of change in voltage level of the high-voltage pulse from the low level to the high level is controlled by changing an ON resistance of a load transistor out of transistors forming the first prebuffer based on the control signal, and
the speed of change in voltage level of the high-voltage pulse from the high level to the low level is controlled by changing an ON resistance of a load transistor out of transistors forming the second prebuffer based on the control signal.

6. The PDP driver of claim 5, wherein the load transistor of the first prebuffer is formed by two first load transistors connected in parallel with each other,
the load transistor of the second prebuffer is formed by two second load transistors connected in parallel with each other,
the speed of change in voltage level of the high-voltage pulse from the low level to the high level is controlled by controlling the number of transistors in ON states out of the two first load transistors based on the control signal, and
the speed of change in voltage level of the high-voltage pulse from the high level to the low level is controlled by controlling the number of transistors in ON states out of the two second load transistors based on the control signal.

7. The PDP driver of claim 6, wherein each of the first load transistors and the second load transistors is controlled according to a signal obtained by performing AND operation on the input signal and the control signal, in controlling an associated one of the speeds.

8. The PDP driver of claim 7, wherein the first load transistors and the second load transistors have different transistor sizes.
